(19) United States
(12) Patent Application Publication
(10) Pub. No.: US 2016/0197923 A1
(43) Pub. Date: Jul. 7, 2016

(54) SECURE, UNINTERRUPTED OPERATION OF MOBILE DEVICES

(71) Applicant: THOMSON LICENSING, Issy Les Moulineaux (FR)

(72) Inventors: Andrè SCHLATTER, (US); Magdy MEGEID, Zürich (CH); Fabian Nicola SCHLUMBERGER, Schwerzenbach (CH); Stefan Andreas DUBACH, (US)

(21) Appl. No.: 14/392,299

(22) PCT Filed: Jun. 25, 2013
(86) PCT No.: PCT/US2013/047471

§ 371 Date: Dec. 23, 2015

(51) Int. Cl. H04L 29/06

(52) U.S. Cl. CPC H04L 63/10; H04L 63/0861

(57) ABSTRACT

The disclosed embodiments relate to a system and method for secure, uninterrupted operation of a mobile device. The method includes identifying, at repeated intervals, a voice of a device operator. The method also includes determining if the device operator is an authorized user of the mobile device based on the voice. Additionally, the method includes continuing an operation of the mobile device if the device operator is an authorized user. Further, the method includes interrupting operation of the mobile device if the device operator is not an authorized user.

### FIELD OF THE INVENTION

The present disclosure relates generally to mobile devices. More specifically, the present disclosure relates to a system for secure, uninterrupted operation of mobile devices.

### BACKGROUND OF THE INVENTION

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Mobile devices contain sensitive data, and as such, enable users to protect this data, and associated functions, from unauthorized users. One approach to securing mobile devices is to periodically check for the presence of an authorized user, and to deny access to the device unless an authorized user is present. Typical mobile phones, for example, use a lock timer which prevents the activation of functions, and access to data, after a predetermined time has elapsed. The lock timer starts to count down when the device becomes idle, i.e., when the user stops operating the device. If a user operates or touches the device, the lock timer is reset, and operation of the device continues. However, if the lock timer counts down to zero, the device switches into the locked state. When in the locked state, getting access to functions and data is prevented until the user provides a pass code. The pass code may be spoken or typed into the device. However, such entry methods may be observed by someone close to the user. In such a scenario, an unauthorized user may use the stolen pass code to access data and use the mobile device. A method for secure, uninterrupted operation of a mobile device is therefore desirable.

### SUMMARY OF THE INVENTION

Certain aspects commensurate in scope with the disclosed embodiments are set forth below. It should be understood that these aspects are presented merely to provide the reader with a brief summary of certain forms the disclosure might take and that these aspects are not intended to limit the scope of the disclosure. Indeed, the disclosure may encompass a variety of aspects that may not be set forth below.

Embodiments relate to a system and method for secure, uninterrupted operation of a mobile device. The method includes identifying, at repeated intervals, a voice of a device operator. The method also includes determining if the device operator is an authorized user of the mobile device based on the voice. Additionally, the method includes continuing an operation of the mobile device if the device operator is an authorized user. Further, the method includes interrupting operation of the mobile device if the device operator is not an authorized user.

### BRIEF DESCRIPTION OF THE DRAWINGS

Advantages of the disclosure may become apparent upon reading the following detailed description and upon reference to the drawings in which:

FIG. 1 is a block diagram of an exemplary mobile device in accordance with embodiments of the present disclosure;

FIG. 2 is a flow chart illustrating an exemplary mobile device operating in accordance with embodiments of the present disclosure;

FIG. 3 is a flow chart illustrating an exemplary mobile device operating in accordance with embodiments of the present disclosure; and

FIGS. 4A-4B are block diagrams of exemplary user interfaces, in accordance with embodiments of the present disclosure.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of the present disclosure.

Mobile devices, such as mobile phones, are easy targets for theft because of their mobile nature. As such, there are numerous ways to secure these devices, typically through infrequent requests for pass codes. In one embodiment, instead of using a password to be typed on the keyboard or touch screen, biometric information recognition, e.g. voice recognition, and the like, is used to ensure the current user is an authorized user. Advantageously, vocal biometric information recognition can be performed much more frequently than pass code entry because it does not interrupt the user from operating the device.

The following discussion uses voice recognition as one example of biometric information recognition that could be used to secure mobile devices. The same techniques also apply to other biometric information recognition methods. The mobile device discussed with reference to the following figures includes a wide variety of mobile devices that store data, and enable various applications for various users.

Mobile devices like cellphones and smartphones support voice commands that start applications, and operate the device. Accordingly, it is desirable to protect devices using voice recognition. The meaning of voice recognition in this context is that the user is identified based on the characteristics of the voice, as opposed to speech recognition, where the spoken word is identified to match to the right command.

Everybody has an individual voice characteristic based on the physical structure of the individual's vocal tract, and individual behavioral characteristics. Each user has a unique voice which can be used to unlock a device using voice recognition. Accordingly, in one embodiment, vocal recognition is used for periodic authorization of a user on a mobile device. As described herein, voice recognition can be performed without having to interrupt the user from regular use of the device. The device automatically switches into a locked state if the authorized user is not present, and switches into an active state when an authorized user's speaking voice is sensed by the microphone.

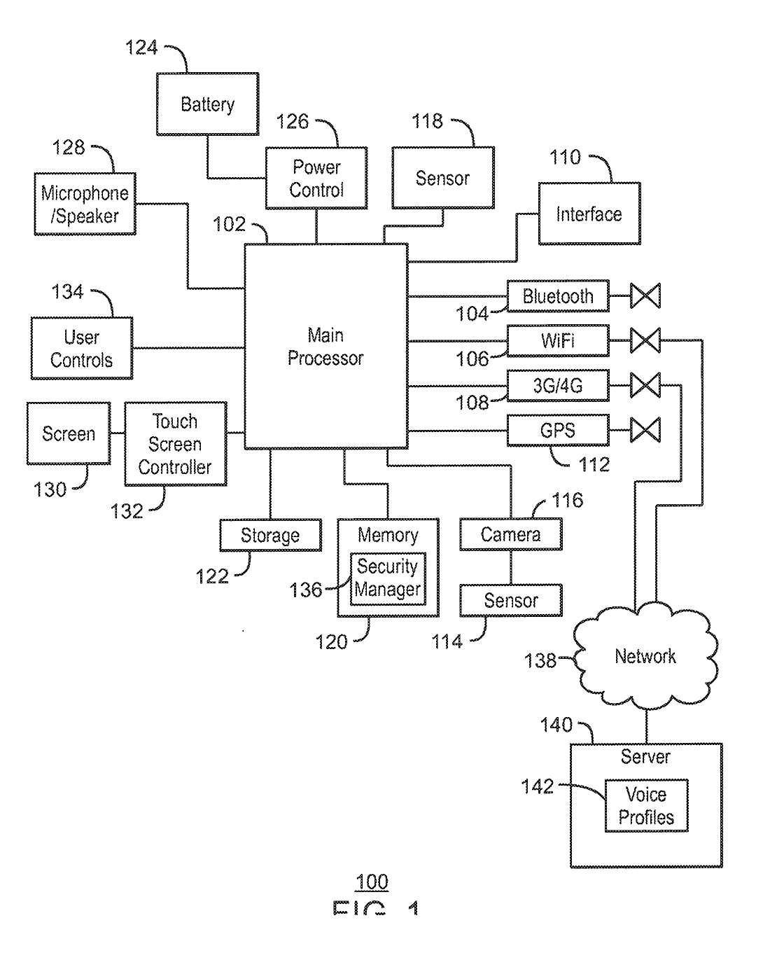

Turning initially to FIG. 1, which is a block diagram of an exemplary mobile device 100 in accordance with embodiments of the present disclosure. The mobile device 100 is a computational device, such as a laptop computer, tablet, mobile telephone, global positioning system (GPS) device, and so on.

In one embodiment, the mobile device 100 is a smartphone. The smartphone typically has the ability to send and receive phone calls and text messages, take pictures and videos, play back audio and video content, run applications, such as text processing programs and video games, and interface with the Internet through a network 138. The network 138 may include one or more networks, such as cellular networks or local wireless networks. Many smartphones include GPS capabilities, and include a touchscreen panel as part of the user interface.

For example, the smartphone includes a main processor 102 that is coupled to the other components shown. The main processor 102 routes information between the various components, such as the Bluetooth interface 104, Wifi interface 106, and 3G/4G interface 108. The main processor 102 also processes audio and video content for play back either directly on the device 100 or on an external device through the audio/video interface 110. Communication with the smartphone may be controlled through a set of antennas connected to Bluetooth interface 104, wifi interface 106, and 3G/4G interface 108. An additional antenna may be used for receiving GPS information through the GPS interface 112. A camera sensor 114 may be coupled through a camera interface 116 to the main processor 102. The camera sensor 114 and interface 116 create video content in either photo or video operational modes. An inertial sensor 118, such as one or more accelerometers or gyroscopes, may be included for determining device orientation and movement.

A memory 120 and storage device 122 may be coupled to the main processor 102. The memory 120 may be used for storing specific information related to operation of the smartphone and needed by the main processor 102. The storage device 122 may be used for storing audio, video, photos, or other data stored and retrieved by the user. A battery 124 is included for powering the smartphone and may be interfaced through a power control circuit 126 that may include a battery charging interface (not shown).

The user interface includes a speaker and microphone 128 for use with phone calls, audio recording and playback, or voice activation control. The smartphone may include a touch screen 130 coupled to the main processor 102 through a touch screen controller 132. The touch screen 130 may be either a single touch or multi touch screen using one or more of a capacitive and resistive touch sensor. The smartphone may also include additional user controls 134, such as but not limited to, an on and off button, an activation button, volume controls, ringer controls, and a multi-button keypad or keyboard.

In one embodiment, the memory 122 includes a security manager 136. The security manager 136 may be module configured for periodic authorization of the user of the mobile device 100. Periodic authorization may be performed whether or not the device 100 is being operated.

In such an embodiment, the device 100 automatically switches between active and locked states based on whether an authorized user's voice is recognized. In an active state, the device 100 operates without interruption. However, in a locked state, further operation may be limited to operations that facilitate placing the device 100 back in possession of an authorized user.

For example, if the device 100 is lost or stolen, the device 100 may allow an unauthorized user to send a message to the owner or other authorized user. Message types include, but are not limited to, Short-Message-Service (SMS), email, a voice call, and a voice mail. In one embodiment, the device 100 displays contact information, such as email-address, phone number, or the like. In this way, the unauthorized user may be enabled to call the owner's landline number, or a service provider's hotline to report the discovery. In scenarios where recognition cannot be performed, another authorization method may alternately be performed, such as a pass code entry.

Advantageously, voice recognition and command recognition may appear to happen seamlessly to the authorized user. In fact, in one embodiment, both are performed locally on the device 100. However, in another embodiment, the voice recognition is done upon a profile on a server (e.g., cloud), and command recognition is done locally on the device 100. Having the voice profile (or a backup of the profile) stored on a server is advantageous because such a profile can be used for another device without modification, e.g., when the user buys a new device. Additionally, it is also possible to add authorized users to a device supporting multiple users. With multi-user support, the main user can set restrictions for some or all of the other users.

In one embodiment, the device 100 communicates with a server 140 for voice recognition. The server 140 includes voice profiles 142 for authorized users of the device 100. The device 100 analyzes the user's voice during typical operation, e.g., voice commands or speaking in telephone conversation, to develop the voice profile 142.

The user may be authenticated when the user speaks to the mobile device 100 using voice commands. The mobile device enters (or remains in) an active state upon recognizing an authorized user's voice. Advantageously, because this authorization is done with a text-independent method, no specified password is used. Instead, voice profiles 142 of authorized users are developed by listening to authorized users' voices during uses of the mobile device, such as during a telephone conversation. Not using a pass code for authorization is also advantageous because there is no pass code available to be compromised.

In one embodiment, the voice profile 142 of a remote caller is developed by monitoring the remote caller's voice during telephone conversation. The development of such a profile may be limited to callers that have entries in the user's telephone book, or are in a relationship with the user through a social media account. Additionally, once a caller is recognized, the mobile device 100 may prompt the main user for specific user rights to the device 100.

In another embodiment, the voice of the device operator maybe identified in response to a voice recognition trigger (e.g., a button actuation, a tap on the mobile device 100, and/or a movement of the mobile device 100.

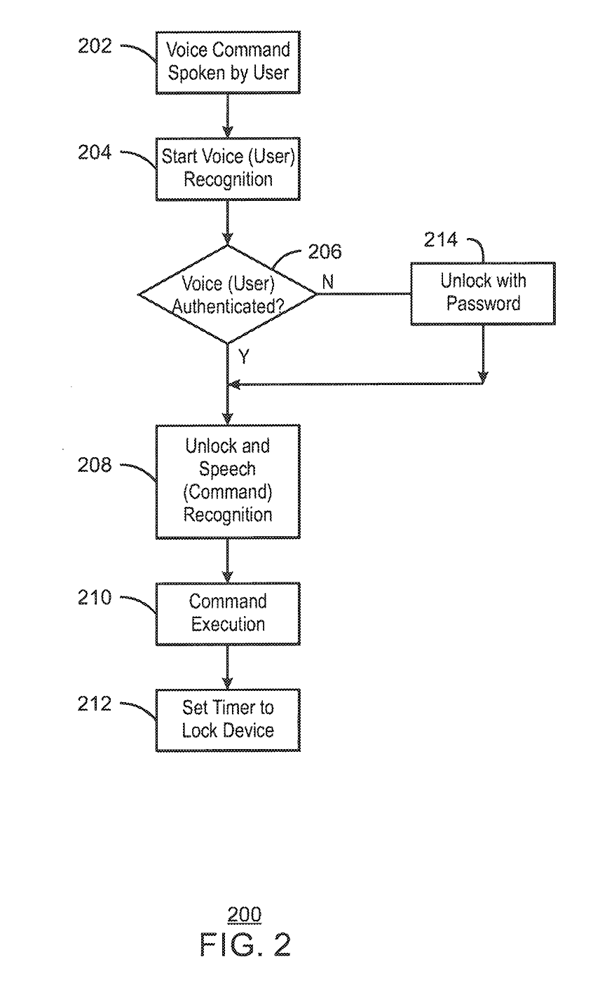

Turning now to FIG. 2, which is a flow chart of a method 200 for an exemplary mobile device 100 operating in accordance with embodiments of the present disclosure. Advantageously, the method merges the authentication function (voice recognition) with voice commands' speech recognition. Advantageously, the device 100 is secured without a special step actively performed by the user to unlock the device. In this way, the secured device 100 is secured while giving the user the feeling of just starting an application with a voice command.

The method 200 may be performed by the security manager, and begins at step 202, where the user speaks a voice command. At step 204, the security manager 136 performs voice recognition based on the spoken command. At step 206, it is determined whether the voice belongs to an authorized user. If not, at step 214, the device 100 prompts the user to unlock the device 100 using a password. If so, at step 208, the device 100 is unlocked, i.e., enters, or remains in, an active state. At step 210, the device 100 executes the recognized command. At step 212, the security manager 136 may set (or reset) a lockout timer. The device 100, therefore, automatically is protected after a predetermined time of having been unlocked. The timer to lock the device 100 is refreshed each time the authorized user gives commands to the device 100. Additionally, the timer may be suspended during a phone call, enabling the authorized user to hand the device 100 to another person close to the user during an ongoing call.

The more sophisticated the voice profile 142 gets, the more capable the device 100 becomes of accurately recognize the authorized users' voices. However, until that level of recognition is reached the main user may use password protection, as shown in step 214, to unlock the device 100.

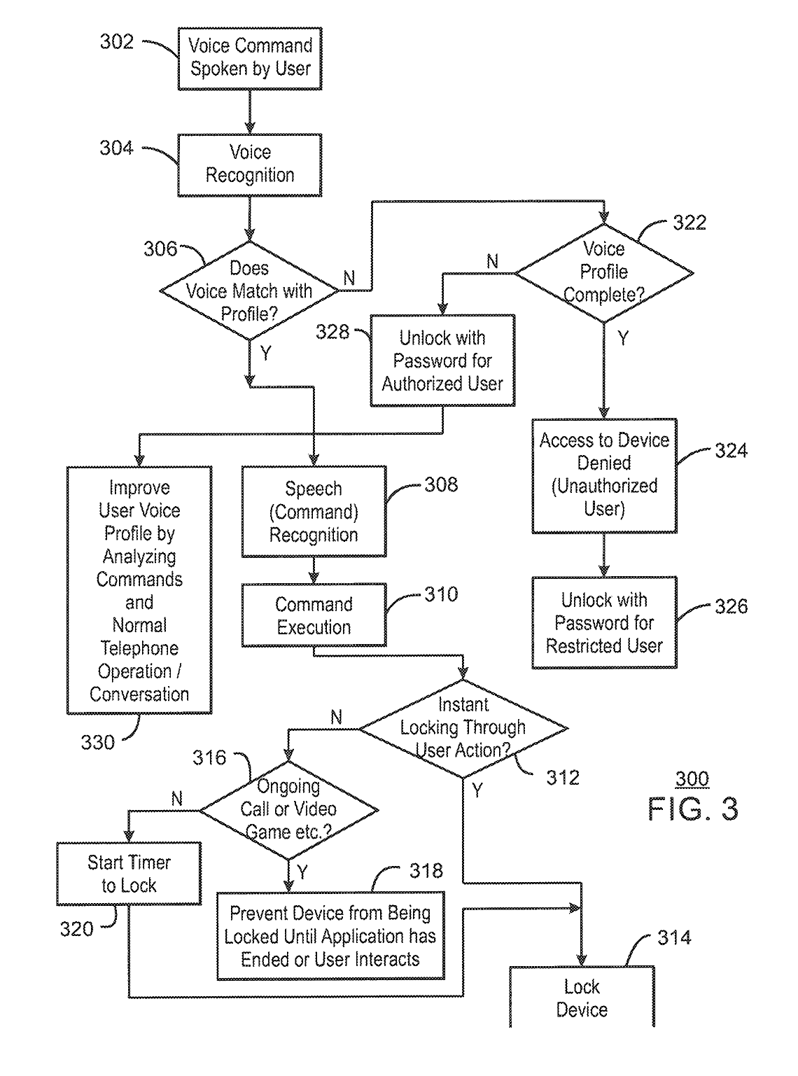

Turning now to FIG. 3, which is a flow chart of a method 300 for an exemplary mobile device 100 operating in accordance with embodiments of the present disclosure. The method 300 begins at step 302, where the user speaks a voice command. At step 304, voice recognition is performed on the spoken command. At step 306, it is determined whether the voice matches an authorized user's profile 142.

If so, at step 308, command recognition is performed. At step 310, the command is executed. At step 312, the security manager 136 may determine whether the user has selected instant locking. If so, at step 314, the device 100 is locked. If not, at step 316, it is determined whether there is an ongoing operation that during which authorization is suspended. In one embodiment, authorized users may suspend the security authorization for the duration of a current application, e.g., to watch a video, play a game, move through a folder of pictures, and so on. If the current application is not to be interrupted for security, at step 318, locking the device 100 is prevented until the application ends, or the authorized user specifies otherwise. If not, at step 320, the lockout timer is set (or re-set).

In addition to voice recognition, the device 100 may also be secured with a password, enabling other users to operate the device 100. An additional level of security is advantageous to protect the device 100 from being used by an unauthorized user after being unlocked by an authorized user. If the voice of the spoken command is not recognized at step 306, at step 322, it is determined whether the voice profile 142 is complete. If so, at step 324, the device 100 denies access to the user. At step 326, the device 100 may be unlocked with a password for restricted use.

If the voice profile 142 is not complete, at step 328, the device 100 may be unlocked with a password for an authorized user. At step 330, the spoken command, and any telephone conversation for an authorized user, is used to further train the voice recognition function.

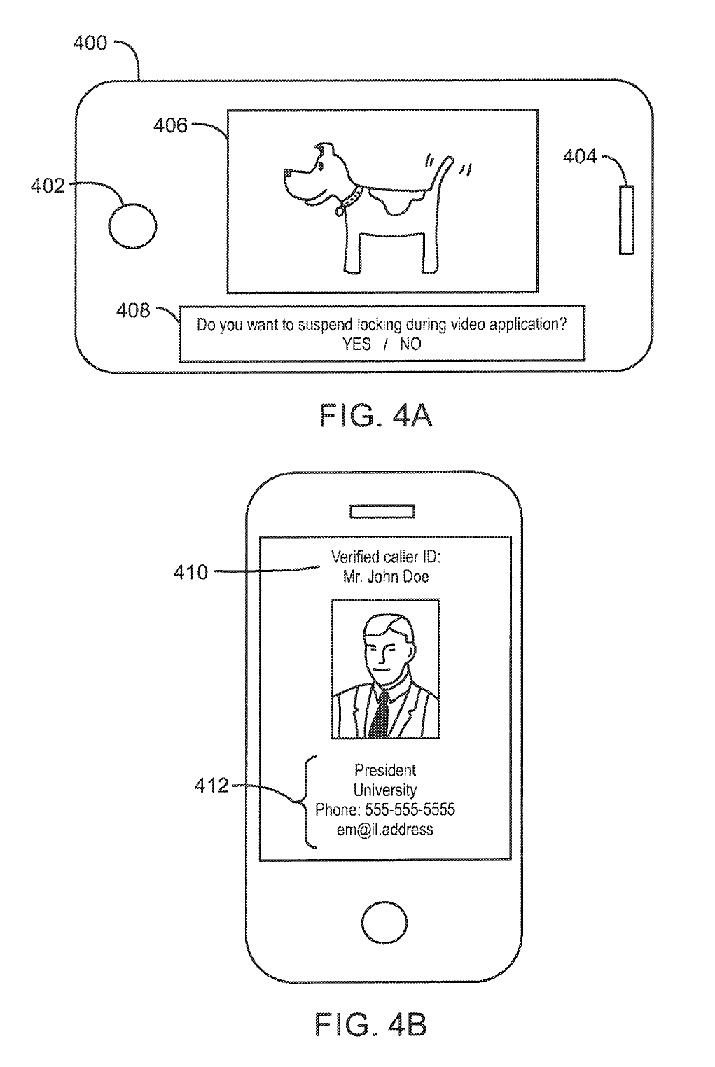

Turning now to FIG. 4A, a block diagram of an exemplary user interface 408 in accordance with embodiments of the present disclosure is shown. The device 400 includes a speaker 404, microphone 402, display 406, and the interface 408, e.g., a graphical user interface within a touchscreen display. As stated previously, authorized users may suspend the security authorization for a current application, e.g., to watch a video. Advantageously, the authorized user may hand the device to another person who may not be authorized to use it, and let this other person use the current application, e.g., watch the video. However, the use of a different application without further authorization by the authorized user is prevented. There may be exceptions, such as the use of emergency call numbers.

Turning now to FIG. 4B, a block diagram of an exemplary user interface in accordance with embodiments of the present disclosure is shown. The different profiles 142 stored on a server 140 can be used to verify the identities of the main user, authorized users, recipients of calls from, and callers to, the authorized users. Developing the profile 142 of a caller who is not an authorized user, enables an authorized user to automatically view personal information (e.g. name, email address, photo or electronic business card) about the caller. The device includes an interface which includes a photo, along with the name 410 and personal information 412 about the caller. The receiver of the call may also be recognized during the call, and automatically send verification information back to the caller. As soon as identification occurs, a notification may appear on the screen, or a specified tone could be played to indicate the successful verification. This notification may accompany the personal information.

In one embodiment, such a caller verification feature may be associated with a social or professional contact, to retrieve the personal information. This may be advantageous for anyone looking for a reliable source of information, e.g., a trustful introduction. In another embodiment, as soon as a clerk at an office answers a call, a customer profile of the caller may be provided. This information may be from a local database of information collected from the customer during a first sale, for example.

Additionally, using voice recognition also enables the device 100 to separate individual billing for phone calls by the authorized users. Typically, a device may have a subscription with a service provider. In this way, all calls dialed from one account (number) are charged on this account independent of who the caller was. However, in one embodiment, the caller verification by voice recognition allows one user to use multiple devices, and be billed for each use, regardless of the device used.

It is to be understood that the present disclosure may be implemented in various forms of hardware, software, firmware, special purpose processors, or a combination thereof. Preferably, the present disclosure is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present disclosure is programmed. Given the teachings herein, one of ordinary skill in the related art will be able to contemplate these and similar implementations or configurations of the present disclosure.

While the disclosure may be susceptible to various modifications and alternative forms, specific embodiments have been shown by way of example in the drawings and will be described in detail herein. However, it should be understood that the disclosure is not intended to be limited to the particular forms disclosed. Rather, the disclosure is to cover all modifications, equivalents and alternatives falling within the scope of the disclosure as defined by the following appended claims.

What is claimed is:

1. A method (300) for operating a mobile device (100), comprising:
identifying, at repeated intervals, a voice of a device operator;
determining if the device operator is an authorized user of the mobile device (100) based on the voice;
continuing an operation of the mobile device (100) if the device operator is the authorized user; and
interrupting the operation of the mobile device (100) if the device operator is not the authorized user.

2. The method (300) of claim 1, comprising continuing the operation of the mobile device (100) if the authorized user specifies the operation is not interrupted.

3. The method (300) of claim 2, comprising ignoring a voice command for an additional operation that is not requested by the authorized user.

4. The method (300) of claim 1, wherein the voice is associated with a telephone conversation on the mobile device (100).

5, The method (300) of claim 1, wherein the voice is associated with a voice command for the mobile device (100).

6. The method (300) of claim 1, comprising identifying the voice of the device operator in response to a voice recognition trigger, comprising a button, a tap on the mobile device (100), and a movement of the mobile device (100).

7. The method (300) of claim 1, wherein interrupting the operation of the mobile device (100) comprises presenting contact information for an authorized user of the mobile device (100).

8. The method (300) of claim 1, comprising authorizing an unauthorized user to place a phone call to an authorized user of the mobile device (100).

9. A mobile device (100), comprising:
a processor (102); and
a memory (120) comprising instructions configured to cause the processor (102) to:
identify, at repeated intervals, a voice of a device operator;
determine if the device operator is an authorized user of the mobile device (100) based on the voice;
continue an operation of the mobile device (100) if the device operator is the authorized user; and
interrupt the operation of the mobile device 100 if the device operator is not the authorized user.

10. The mobile device (100) of claim 9, comprising instructions configured to cause the processor (102) to continue the operation of the mobile device (100) if an authorized user specifies the operation is not interrupted.

11. The mobile device (100) of claim 10, comprising instructions configured to cause the processor (102) to ignore a voice command for an additional operation that is not requested by the authorized user.

12. The mobile device (100) of claim 9, wherein the voice is associated with a telephone conversation on the mobile device (100).

13. The mobile device (100) of claim 9, wherein the voice is associated with a voice command for the mobile device (100).

14. The mobile device (100) of claim 9, comprising instructions configured to cause the processor (102) to identify the voice of the device operator in response to a voice recognition trigger, comprising a button, a tap on the mobile device (100), and a movement of the mobile device (100).

15. The mobile device (100) of claim 9, comprising instructions configured to cause the processor to authorize an unauthorized user to place a phone call to an authorized user of the mobile device (100).
